(19) United States
(12) Patent Application Publication
(10) Pub. No.: US 2021/0406981 A1
(43) Pub. Date: Dec. 30, 2021

(54) METHOD AND APPARATUS OF DETERMINING DISPLAY PAGE, ELECTRONIC DEVICE, AND MEDIUM

(71) Applicant: Beijing Baidu Netcom Science Technology Co., Ltd., Beijing (CN)

(72) Inventors: Jiamei KANG, Beijing (CN); Shengran CHE, Beijing (CN); Hanyao SHAO, Beijing (CN)

(21) Appl. No.: 17/036,155

(22) Filed: Sep. 29, 2020

(30) Foreign Application Priority Data
Jun. 30, 2020 (CN) 202010616832.1

(51) Int. Cl. G06Q 30/06; G06F 16/28

(52) U.S. Cl. CPC G06Q 30/0631; G06F 16/285

(57) ABSTRACT

The present disclosure discloses a method and apparatus of determining a display page, an electronic device and a medium, which relates to a field of information recommendation and may be used in fields of deep learning, cloud computing and cloud service. The specific implementation scheme includes: acquiring attribute information of a user, wherein the attribute information includes position information; determining, based on the position information, at least one first information category for the user in a preset first information dimension; acquiring recommendation information classified into each first information category of the at least one first information category; and determining the display page for the user based on the preset first information dimension, the at least one first information category, and the recommendation information classified into the each first information category.

### CROSS REFERENCE TO RELATED APPLICATIONS

This application claims priority to the Chinese Patent Application No. 202010616832.1 filed on Jun. 30, 2020, which is incorporated herein by reference in its entirety.

### TECHNICAL FIELD

The present disclosure relates to a field of information recommendation, and more particularly, to a method and apparatus of determining a display page, an electronic device, and a non-transitory medium.

### BACKGROUND

Various client applications are developed in order to meet different application requirements.

Different client applications provide different types of information, and users need to use different client applications when acquiring information. In order to facilitate enterprise knowledge management, it is considered to integrate multiple types of information into the same client application. However, information modules displayed on a display page of the client application are fixed. In the case where too much information are integrated in the client application, it is inefficient to find the information required by the user through the displayed fixed information modules. For example, when a designer wants to find design-related information, he needs to filter design-related knowledge information from multiple pieces of professional knowledge information. This will undoubtedly take a long time of the user to filter the required information and reduce user experience.

### SUMMARY

The present disclosure provides a method and apparatus of determining a display page, an electronic device, and a non-transitory medium.

One aspect of the present disclosure provides a method of determining a display page, including: acquiring attribution information of a user, wherein the attribution information includes position information; determining, based on the position information, at least one first information category for the user in a preset first information dimension; acquiring recommendation information classified into each first information category of the at least one first information category; and determining the display page for the user based on the preset first information dimension, the at least one first information category, and the recommendation information classified into the each first information category.

Another aspect of the present disclosure provides an apparatus of determining a display page, including: an attribution information acquisition module configured to acquire attribution information of a user, wherein the attribution information includes position information; an information category determination module configured to determine, based on the position information, at least one first information category for the user in a preset first information dimension; a recommendation information acquisition module configured to acquire recommendation information classified into each first information category of the at least one first information category; and a page determination module configured to determine the display page for the user based on the first information dimension, the at least one first information category, and the recommendation information classified into the each first information category.

Another aspect of the present disclosure provides an electronic device, including: one or more processors; and a storage device for storing one or more programs, wherein the one or more programs, when executed by the one or more processors, cause the one or more processors to perform the above-mentioned method of displaying the display page.

Another aspect of the present disclosure provides a non-transitory computer-readable storage medium having executable instructions stored thereon that, when executed by a processor, causes the processor to perform the above-mentioned method of displaying the display page.

Another aspect of the present disclosure provides a computer program including computer-executable instructions used to, when executed, perform the above-mentioned method of displaying the display page.

### BRIEF DESCRIPTION OF THE ACCOMPANYING DRAWINGS

The above and other objects, features, and advantages of the present disclosure will be more apparent through the following description of embodiments of the present disclosure with reference to the accompanying drawings, in which:

FIG. 1 schematically shows an application scene of a method and apparatus of determining a display page, an electronic device, and a non-transitory medium according to the embodiments of the present disclosure;

FIG. 2 schematically shows a flowchart of a method of determining a display page according to an embodiment of the present disclosure;

FIG. 3A˜FIG. 3B schematically show exemplary diagrams of the display page determined by the method described by FIG. 2 according to an embodiment of the present disclosure;

FIG. 4 schematically shows a flowchart of a method of determining a display page according to another embodiment of the present disclosure;

FIG. 5 schematically shows a flowchart of a method of determining a display page according to yet another embodiment of the present disclosure;

FIG. 6 schematically shows an exemplary diagram of the display page determined by the method described by FIG. 5;

FIG. 7 schematically shows a flowchart of a method of determining a display page according to yet another embodiment of the present disclosure;

FIG. 8 schematically shows a structural block diagram of an apparatus of determining a display page according to an embodiment of the present disclosure; and

FIG. 9 schematically shows a block diagram of an electronic device adapted for performing the method of determining the display page according to an embodiment of the present disclosure.

### DETAILED DESCRIPTION

Hereinafter, embodiments of the present disclosure will be described with reference to the accompanying drawings. It should be understood, however, that these descriptions are merely exemplary and are not intended to limit the scope of the present disclosure. In the following detailed description, for ease of interpretation, many specific details are set forth to provide a comprehensive understanding of the embodiments of the present disclosure. However, it is clear that one or more embodiments may also be implemented without these specific details. In addition, in the following description, descriptions of well-known structures and technologies are omitted to avoid unnecessarily obscuring the concepts of the present disclosure.

The terms used herein are for the purpose of describing specific embodiments only and are not intended to limit the present disclosure. The terms “comprising”, “including”, etc. used herein indicate the presence of the feature, step, operation and/or part, but do not exclude the presence or addition of one or more other features, steps, operations or parts.

All terms used herein (including technical and scientific terms) have the meanings generally understood by those skilled in the art, unless otherwise defined. It should be noted that the terms used herein shall be interpreted to have meanings consistent with the context of this specification, and shall not be interpreted in an idealized or too rigid way.

In the case of using the expression similar to “at least one of A, B and C”, it should be explained according to the meaning of the expression generally understood by those skilled in the art (for example, “a system having at least one of A, B and C” should include but not be limited to a system having only A, a system having only B, a system having only C, a system having A and B, a system having A and C, a system having B and C, and/or a system having A, B and C).

The embodiments of the present disclosure provide a method and apparatus of determining a display page to improve knowledge acquisition efficiency. The method of determining the display page includes: acquiring attribution information of a user, wherein the attribution information includes position information; determining, based on the position information, at least one first information category for the user in a preset first information dimension; acquiring recommendation information classified into each first information category of the at least one first information category; and determining the display page for the user based on the preset first information dimension, the at least one first information category, and the recommendation information classified into the each first information category.

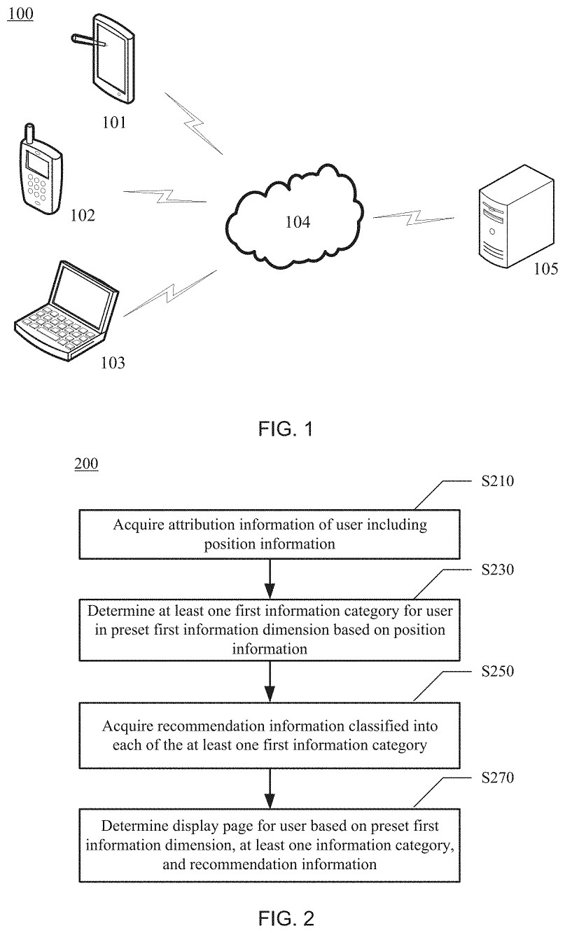

FIG. 1 schematically shows an application scene of a method and apparatus of determining a display page, an electronic device, and a non-transitory medium according to the embodiments of the present disclosure; It should be noted that FIG. 1 only shows an example of the application scene in which the embodiments of the present disclosure may be applied so as to help those skilled in the art understand technical contents of the present invention. It does not mean that the embodiments of the present disclosure cannot be used for other apparatuses, systems or scenes.

As shown in FIG. 1, an application scene 100 of this embodiment may include, for example, terminal devices 101, 102, 103, a network 104, and a server 105. The network 104 is used to provide a non-transitory medium of a communication link between the server 105 and the terminal devices 101, 102, 103. The network 104 may include various connection types, such as wired or wireless communication links, and so on.

The terminal devices 101, 102, 103 may be, for example, various electronic devices with display screens, including but not limited to smart phones, tablet computers, laptop computers, desktop computers, and so on. The terminal devices 101, 102, 103 may be, for example, installed with various client applications, such as text editing applications, audio editing applications, video editing applications, instant messaging applications, intelligent office platforms, etc. (for example only).

The server 105 may be, for example, a server that provides support to the client applications installed on the terminal devices 101, 102, 103. Illustratively, the server 105 may feed back the display page of the client application to the terminal device in response to a request of the terminal device.

In order to enable the client application installed on the terminal device to display multiple types of information to the user, the server 105 may also, for example, maintain a knowledge framework based on the information uploaded by the terminal device via multiple client applications, and classify the uploaded information into different information categories. When the terminal device sends a request to the server to obtain the display page of the client application, the server may determine the information category matching the user based on the attribute information of the user using the client application, and set the display page according to the information category determined. In this way, the recommendation information in the display page of the client application is the information required by the user, which improves the user's efficiency in obtaining information.

Illustratively, when the client application is an intelligent office platform, the information category may be set according to the position, professional field of expertise, project in charge, department and/or team of the employee in the enterprise, so as to improve the work efficiency. For example, when the user using the client application is a product designer, the determined information category matched with the user may include a design category, a product operation category, a user experience category, and so on. When the user is a project dispatcher, the determined information category matched with the user may include a team collaboration category, a task management category, a communication strategy category, and so on.

It should be noted that the method of determining the display page according to the embodiment of the present disclosure may be performed by the server 105, for example. Correspondingly, the apparatus of determining the display page provided by the embodiment of the present disclosure may be arranged in the server 105, which will not be repeated here.

It should be understood that the number and types of the terminal devices, network and server in FIG. 1 are merely illustrative. According to implementation needs, there may be any number and types of terminal devices, networks and servers.

The method of determining the display page according to the embodiment of the present disclosure will be described in detail below through FIG. 2 to FIG. 7 with reference to the application scene described in FIG. 1.

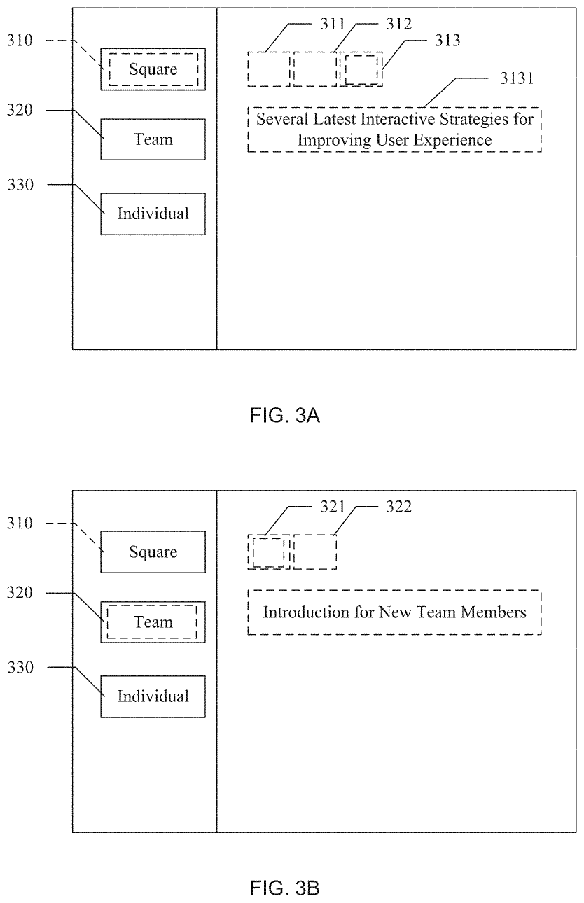

FIG. 2 schematically shows a flowchart of a method of determining a display page according to an embodiment of the present disclosure. FIG. 3A˜FIG. 3B schematically show exemplary diagrams of the display page determined by the method described by FIG. 2 according to the embodiment of the present disclosure.

As shown in FIG. 2, a method 200 of determining the display page according to this embodiment, for example, may include operations S210 to S270.

In operation S210, attribute information of the user is acquired, and the attribute information includes position information.

According to the embodiment of the present disclosure, the operation S210 may be executed when the terminal device sends a display page acquisition request to the server. The display page acquisition request includes account information. In the operation S210, the attribute information of the user may be acquired based on the account information.

Illustratively, the server may pre-store user's account information and attribute information, and there is a mapping relationship between the account information and attribute information of the same user. In the operation 210, the attribute information may be determined based on the account information having the mapping relationship. The attribution information of the user may include, for example, personal attribution information and/or social attribution information of the user. The personal attribute information may include, for example, appearance information, age information, preference information, and so on. The social attribute information may include, for example, position information, kinship information, social activity information, and so on.

Illustratively, when the display page is a display page of the enterprise's intelligent office platform, in order to improve office efficiency and show users interested information in the office process, the attribute information includes at least the position information, and may also include service age, department, project in charge, schedule and other information. The position information may indicate the user's status in performing tasks in the organization or team. For example, the position information may be composed of titles and business in charge, and may include sales directors, interaction designers, media managers, training specialists, human resources specialists, and the like.

In operation S230, at least one first information category for the user in a preset first information dimension is determined based on the position information.

According to the embodiment of the present disclosure, the preset first information dimension may be the same for different users, for example. However, in the operation S230, the first information category is determined based on the position information. The first information dimension may include a plurality of first information categories. The operation S230 is to filter information of the first information category matching the position information from the plurality of first information categories for display. In one embodiment, the number of the preset first information dimension may be multiple. According to the actual needs, a certain first information dimension may, for example, always include a specific first information category. In other words, for different position information, the determined first information category matched with the position information in the certain first information dimension includes the specific first information category.

Illustratively, as shown in FIG. 3A to FIG. 3B, the first information dimension may include, for example, a “square” dimension 310, a “team” dimension 320, and an “individual” dimension 330. As shown in FIG. 3A, the “square” dimension 310 may include specific first information categories, namely a “subscription” category 311 and a “recommendation” category 312. The “square” dimension 310 may further include a “design” category 313, a “sales” category, a “management” category, etc. set according to the position information. When the position information is an interaction designer, the first information category for the user determined by the operation S230 includes the “design” category 313 in the “square” dimension 310; When the position information is a sales specialist, the first information category for the user determined by the operation S230 includes the “sales” category in the “square” dimension 310. As shown in FIG. 3B, the “team” dimension 320 may include specific first information categories, namely a “team” category 321 and a “project” category 322. The recommendation information classified into the “team” category may, for example, include the recommendation information of “Introduction for New Team Members”. The “individual” dimension may include only an “individual” category.

In operation S250, the recommendation information classified into each first information category of the at least one first information category is acquired.

According to the embodiment of the present disclosure, the server may, for example, classify the stored recommendation information in advance, so as to classify the stored recommendation information into the first information category in the above-mentioned preset first information dimension. At least one piece of recommendation information is classified into each of the first information category. In the operation S250, a predetermined number of pieces of recommendation information may be acquired, according to the typesetting requirements of the display page, from the recommendation information classified into each of the at least one information category determined in the operation S230. Illustratively, if the typesetting requirements of the display page specify that 3 pieces of recommendation information may be displayed in the “subscription” category, the operation S250 may filter 3 pieces of recommendation information from the recommendation information classified into the “subscription” category.

Illustratively, if the total number of pieces of recommendation information classified into the “subscription” category is less than 3, then all the recommendation information classified into the “subscription” category is acquired. If the total number of pieces of recommendation information classified into the “subscription” category is greater than 3, when acquiring the recommendation information, the top 3 pieces of recommendation information with the latest time of generation, or the top 3 pieces of recommendation information with the highest reading amount, or the top 3 pieces of recommendation information mostly matching the attribute information of the user may be acquired.

In operation S270, the display page for the user is determined based on the preset first information dimension, the at least one first information category, and the recommendation information classified into the each first information category.

According to the embodiment of the present disclosure, after determining the at least one first information category for the user in the preset first information dimension and the recommendation information classified into the each first information category, the display page may be generated according to a predetermined page template. When the display page is generated, the content indicating the first information dimension may be used as a primary tag in the display page, and the content indicating the each information category in each first information dimension is used as a secondary tag in the display page. The page template specifies the display position of the primary tag, the display position of the secondary tag, and the display position and arrangement of the recommendation information under the secondary tag. The page template may be set according to the actual needs, which is not limited in the present disclosure.

In summary, according to the embodiments of the present disclosure, by determining the first information category based on the position information of the user, it is possible to realize the customized display of the page for the user, so that the recommendation information displayed in the display page is the information required by the user. Compared with the related art, users do not need to filter information valuable to them from a large amount of information, which may effectively improve knowledge acquisition efficiency and improve user experience.

According to the embodiments of the present disclosure, in order to improve the timeliness and accuracy of the recommendation information displayed to the user, when the information of each category determined in the operation S250 is recommended to the user, the recommendation information may be determined according to the user's personal work schedule, for example. Therefore, the attribute information of the user acquired in the operation S210 may, for example, include task item information. In operation S270, when determining the display page for the user, target information among the recommendation information classified into each first information category may be first determined based on the task item information. Then the display page for the user is determined based on the first information dimension, the at least one first information category and the target information.

Illustratively, the task item information may, for example, include the user's schedule information, participating project information, and matters in charge in the participating project. The schedule information may, for example, include meeting arrangement information, meeting name, time of receiving customers, and customer information of customers received. When the first information category determined in the operation S230 includes the design category, if it is determined according to the task item information that the user has a development seminar for client application A this afternoon, and the user is responsible for interaction design in the development project of the client application A, then the target information determined may, for example, include recommendation information 3131 of “Several Latest Interactive Strategies to Improve User Experience” as shown in FIG. 3A.

Illustratively, the task item information may be updated based on information uploaded in real time by the terminal device via the client application, so as to ensure the timeliness and effectiveness of the recommendation information displayed to the user. For example, the intelligent office platform client application may provide a schedule module, a meeting module, a project module, and so on. The user may input schedules, meeting minutes, project information, and so on through these modules. The updated task item information may be, for example, sent by the client application to the server in response to the user's editing of the information in these modules. After receiving the task item information uploaded by the client application, the server replaces the original task item information bound with the account information with the task item information uploaded by the client application, so as to update the task item information in the server.

According to the embodiment of the present disclosure, in order to improve the accuracy of the recommendation information displayed to the user, the recommendation information displayed to the user may also be determined according to the user's browsing history.

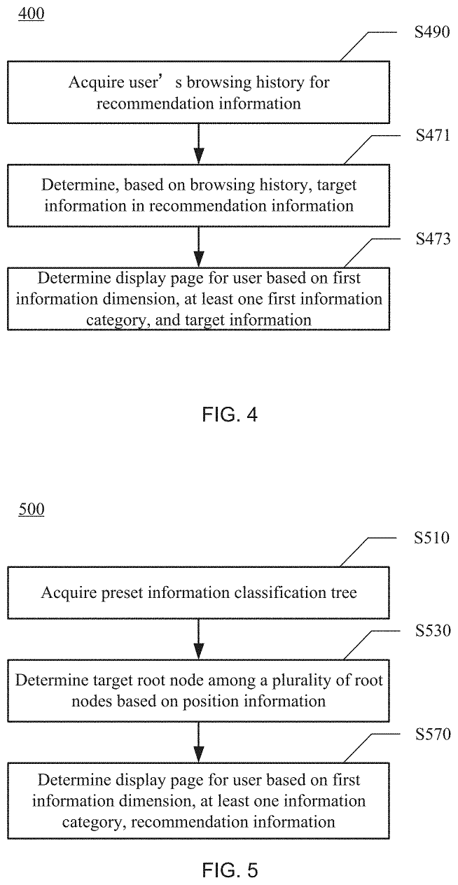

FIG. 4 schematically shows a flowchart of a method of determining a display page according to another embodiment of the present disclosure.

As shown in FIG. 4, a method 400 of determining the display page according to this embodiment may include operation S490 in addition to the above-mentioned operations S210 to S270, and the operation S270 may be performed by operations S471 to S473.

In the operation S490, the user's browsing history for the recommendation information classified into each first information category is acquired.

According to the embodiment of the present disclosure, after determining the first information category for the user, the server may acquire, based on the account information of the user, a browsing log for the user uploaded by the client application in the latest predetermined time period. Then the classification of the recommendation information browsed by the user is determined from the browsing log. In this way, the user's browsing history of the recommendation information classified into each first information category is obtained. The browsing history includes the following information: whether the recommendation information has been viewed by the user, the number of times that the recommendation information has been viewed by the user, and so on.

Illustratively, a tag may be added to each piece of recommendation information according to the information category into which it is classified. The classification of each piece of recommendation information in the browsing log may be determined according to the tag of the recommendation information.

In the operation S471, the target information in the recommendation information classified into the each first information category is determined based on the browsing history.

In the operation S473, the display page for the user is determined based on the first information dimension, the at least one first information category, and the target information.

According to the embodiment of the present disclosure, the operation S471 may include: first determining, based on the browsing history, a predetermined number of pieces of recommendation information with the highest number of times of browsing among the recommendation information classified into each first information category determined in the operation S230, and then filtering the target information from the recommendation information classified into each first information category determined in the operation S230, wherein a similarity between the target recommendation information and the predetermined number of pieces of recommendation information is greater than a similarity threshold. The predetermined number and the similarity threshold, for example, may be set according to the actual needs, which is not limited in the present disclosure. The similarity between two pieces of recommendation information, for example, may be determined based on Euclidean distance and Jaccard distance between two vectors representing the two pieces of recommendation information.

According to the embodiment of the present disclosure, in order to provide the user with recommendation information from more dimensions, for example, to provide the user with other information that is irrelevant to his position information but is of interest to the user, the display page of this embodiment may also display an information access entry for the user to access multi-dimensional information. In this embodiment, an information classification tree may be set. The information classification tree may indicate a plurality of second information dimensions, second information categories for each of the second information dimensions, or even more fine-grained information subcategories. The information classification tree may be displayed through the user's access to the information access entry. Illustratively, in this embodiment, a classification tree display control may be provided in the display page, so that the terminal device may display the information classification tree in response to the operation on the classification tree display control. The plurality of second information dimensions, for example, are the same for different users, and the second information dimension has a dimension setting basis different from that of the first information dimension.

Illustratively, in order to further improve the user experience, in response to the user's operation on the access entry, the display of the information classification tree, for example, may also automatically expand each second information category that the user is interested in. Therefore, in this embodiment, when determining the display page, the second information dimension that the user is interested in may be determined based on the position information of the user, and the information classification tree expanding the second information categories included in the second information dimension may be used as the information classification tree linked to the access entry.

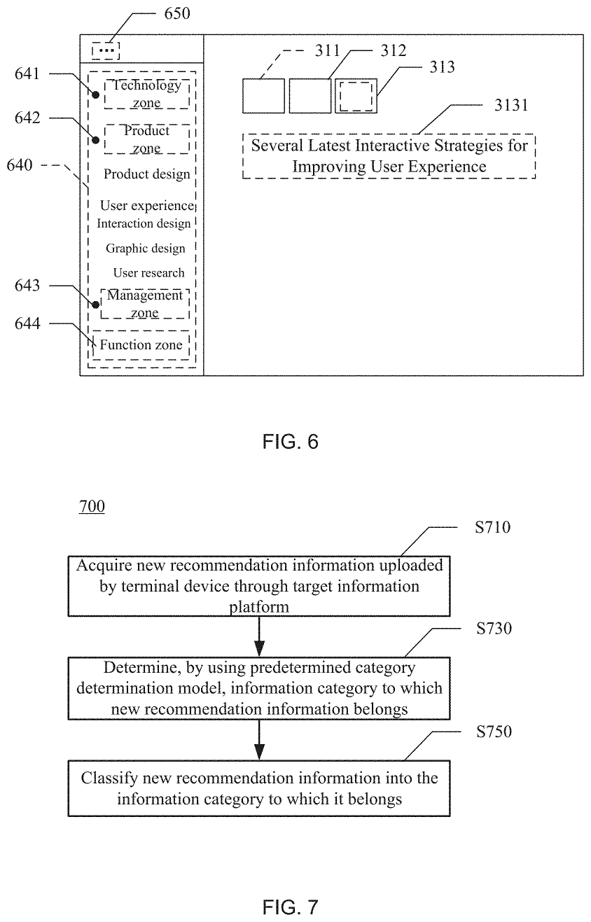

FIG. 5 schematically shows a flowchart of a method of determining the display page according to yet another embodiment of the present disclosure. FIG. 6 schematically show an exemplary diagram of the display page determined by the method described by FIG. 5.

As shown in FIG. 5, a method 500 of determining the display page according to this embodiment may include operations S510 to S530 in addition to the above-mentioned operations S210 to S270, and the operation S270 may be performed by operation S570.

In operation S510, a preset information classification tree is acquired. According to the embodiment of the present disclosure, the information classification tree may include a plurality of root nodes each indicating a second information dimension. Each of the plurality of root nodes includes at least one sub node each indicating a second information category. The second information dimension may, for example, include information dimensions for different professional fields, such as technical dimension, management dimension, product dimension, and so on. For the technical dimension, the second information categories included therein may, for example, include an “Internet technology” category, an “operating system development technology” category, an “application development technology” category, and so on. For the product dimension, the second information categories included therein may, for example, include a “product design” category, a “user experience” category, and so on. It should be understood that the above-mentioned second information dimensions and second information categories are only used as examples to facilitate understanding of the present disclosure. Different second information dimensions and second information categories may be set in different application scenes.

In operation S530, a target root node among the plurality of root nodes is determined based on the position information, wherein the second information dimension indicated by the target root node is matched with the position information.

As shown in FIG. 6, the information classification tree 640 includes four root nodes, namely “technology zone” node 641, “product zone” node 642, “management zone” node 643, and “function zone” node 644, which respectively indicate the technical dimension, product dimension, management dimension and function dimension. When the position information of the user includes the product designer, the target root node determined is the “product zone” node 642 matching the product designer.

In operation S570, the display page for the user is determined based on the first information dimension, the at least one first information category, the recommendation information classified into the each first information category, and the information classification tree.

According to the embodiment of the present disclosure, the operation S570 is similar to the above-mentioned operation S270, except that, as shown in FIG. 6, when the operation S570 determines the display page for the user, the display page determined includes an information classification tree display control 650. The classification tree display control 650 is an interactive control, which may display the above-mentioned information classification tree 640 in response to the user's operation on the classification tree display control 650. The state of the information classification tree displayed is a state in which the sub nodes included in the target root node determined by operation S530 are expanded. In order to avoid page layout confusion, as shown in FIG. 6, when displaying the information classification tree 640, the information classification tree 640 displayed may, for example, cover the content indicating the above-mentioned first information dimension.

It is understood that the classification tree shown in FIG. 6 is only an example to facilitate the understanding of the present disclosure, which is not limited by the present disclosure. According to the actual needs, in addition to the root nodes and the sub nodes, the classification tree may further include leaf nodes attached to the sub nodes, for example. The leaf node indicates information subcategory with finer granularity than the second information category. For example, the sub node indicating the “user experience” category may include a plurality of leaf nodes respectively indicating an “interaction design” subcategory, a “graphic design” subcategory, and a “user research” subcategory.

Illustratively, after the terminal device displays the information classification tree in response to the operation on the information classification tree display control, the terminal device may, in response to the operation on a certain root node, expand and display the sub nodes included in the certain root node in the display position of the information classification tree; and in response to the operation on a certain sub node, expand and display the leaf nodes of the certain sub node in the display position of the information classification tree. In response to the operation on a certain root node, the operation on a certain sub node or the operation on a certain leaf node, it may also display, in the position where the recommendation information classified into the first information category is displayed, the recommendation information classified into the second information category indicated by the certain sub node, the second information category indicated by the certain sub node, and the information subcategory indicated by the certain leaf node.

According to the embodiment of the present disclosure, in order to facilitate the determination of the display page, the server of this embodiment may also classify the stored recommendation information in advance, and, when new recommendation information is acquired, classify the new recommendation information into the existing information category. The existing information category may include the above-mentioned first information category and second information category, and the same recommendation information may be classified into a certain first information category and a certain second information category at the same time.

According to the embodiment of the present disclosure, in order to enable the client application served by the server to integrate multiple types of information, the information uploaded to the server by the terminal device may, for example, include information generated via a variety of information platforms. The variety of information platforms, for example, may include at least two of an information storage platform, a video playback platform, a document editing platform, an information exchange platform, and a project management platform.

Illustratively, the server may be a server providing support for an intelligent office platform used by the enterprise. The above-mentioned variety of information platforms may include, for example, Wiki (multi-person collaborative writing platform), enterprise cloud disk, enterprise forum, chat tool, project management tool, and the like.

Illustratively, in order to facilitate the integration of multiple types of information, the server may, for example, store recommendation information belonging to different information categories in partitions. Moreover, the server may pre-train an information classification model. The information classification model may be a model capable of finding the relationship between the recommendation information and the category of the recommendation information according to a trained recommendation information set that has been tagged. Illustratively, the information classification model may be a deep learning classification model, which may be any of fastText model, TextCNN model, TextRNN model, TextRNN+Attention model, etc.

FIG. 7 schematically shows a flowchart of a method of determining the display page according to yet another embodiment of the present disclosure.

As shown in FIG. 7, a method 700 of determining the display page according to this embodiment may include operations S710 to S750 in addition to the above-mentioned operations S210 to S270.

In operation S710, the new recommendation information uploaded by the terminal device through a target information platform is acquired. The target information platform may be the above-mentioned variety of information platforms, namely, at least one of an information storage platform, a video playback platform, a document editing platform, an information exchange platform, and a project management platform.

In operation S730, the information category to which the new recommendation information belongs is determined by using a predetermined category determination model.

According to the embodiment of the present disclosure, the predetermined category determination model may be the above-mentioned information classification model, for example. Illustratively, output information of the predetermined category determination model may be, for example, a probability that the recommendation information belongs to each of the predetermined plurality of information categories. The operation S730 may, for example, determine that the information category corresponding to the maximum probability (or the probability greater than a probability threshold) is the information category to which the new recommendation information belongs. Illustratively, the output information of the predetermined category determination model may also be directly the information category to which the recommendation information belongs. The probability threshold may be set according to the actual needs. For example, the probability threshold may be a value greater than 0.4.

In operation S750, the new recommendation information is classified into the information category to which it belongs.

The operation S750 may include adding, to the new recommendation information, a tag indicating the information category to which it belongs. Alternatively, the new recommendation information is stored in a storage partition set for the information category to which it belongs. The information category may include the above-mentioned first information category and second information category.

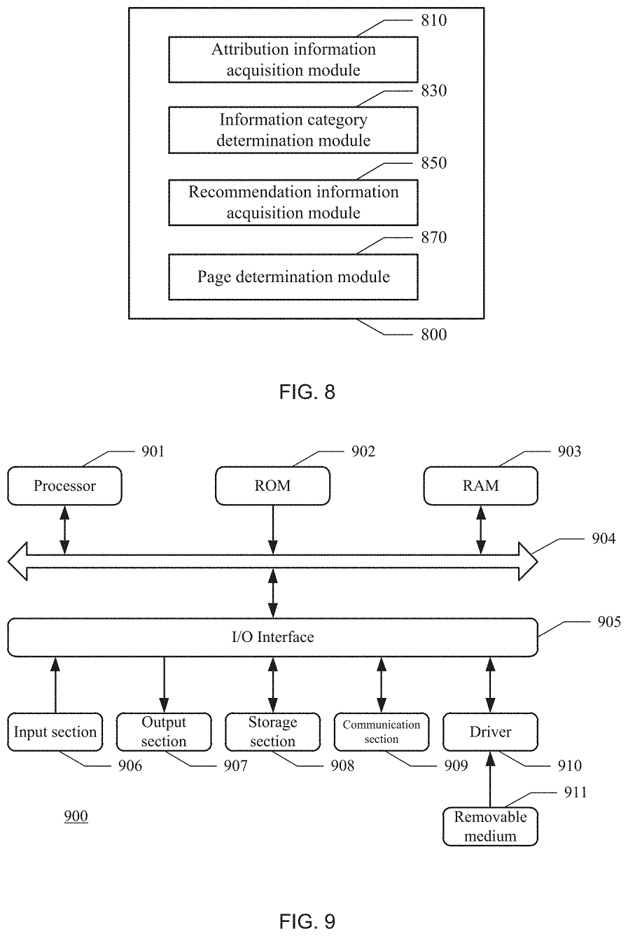

FIG. 8 schematically shows a structural block diagram of an apparatus of determining the display page according to an embodiment of the present disclosure;

As shown in FIG. 8, a device 800 of determining the display page according to this embodiment may include an attribute information acquisition module 810, an information category determination module 830, a recommendation information acquisition module 850, and a page determination module 870.

The attribute information acquisition module 810 is used to acquire the attribute information of the user, which includes the position information. In one embodiment, the attribute information acquisition module 810 may be used, for example, to perform the operation S210 described in FIG. 2, which will not be repeated here.

The information category determination module 830 is used to determine at least one first information category for the user in the preset first information dimension based on the position information. In one embodiment, the information category determination module 830 may be used, for example, to perform the operation S230 described in FIG. 2, which will not be repeated here.

The recommendation information acquisition module 850 is used to acquire the recommendation information classified into each first information category of the at least one first information category. In one embodiment, the recommendation information acquisition module 850 may be used, for example, to perform the operation S250 described in FIG. 2, which will not be repeated here.

The page determination module 870 is used to determine the display page for the user based on the preset first information dimension, the at least one first information category, and the recommendation information classified into the each first information category. In one embodiment, the page determination module 870 may be used, for example, to perform the operation S270 described in FIG. 2, which will not be repeated here.

According to the embodiment of the present disclosure, the above-mentioned device 800 of determining the display page may also include a classification tree acquisition module and a node determination module, for example. The classification tree acquisition module is used to acquire the preset information classification tree including a plurality of root nodes each indicating a second information dimension. Each of the root nodes includes at least one sub node each indicating a second information category. The node determination module is used to determine the target root node among the plurality of root nodes, where the second information dimension indicated by the target root node is matched with the position information. The page determination module 870 may be used, for example, to determine the display page for the user based on the first information dimension, the at least one first information category, the recommendation information classified into the each first information category, and the information classification tree. The display page includes an information classification tree display control such that the display page displays the sub node included in the target root node in response to an operation on the information classification tree display control. In one embodiment, the classification tree acquisition module, the node determination module and the page determination module 870 may be used, for example, to respectively perform operation S510, operation S530 and operation S570 described in FIG. 5, which will not be repeated here.

According to the embodiment of the present disclosure, the above-mentioned device 800 of determining the display page may, for example, also include a browsing history acquisition module for acquiring a user's browsing history for the recommendation information classified into each first information category. The page determination module 870 may, for example, include a target information determination sub module and a display page determination sub module. The browsing history acquisition module may be used, for example, to perform the operation S490 described in FIG. 4. The target information determination sub module and the display page determination sub module, for example, may be used to perform the operations S471 to S473 described in FIG. 4, which will not be repeated here.

According to the embodiment of the present disclosure, the above-mentioned device 800 of determining the display page may, for example, also include a recommendation information acquisition module, a category determination module and an information classification module. These three modules are respectively used to perform the operations S710 to S750 described in FIG. 7, which will not be repeated here.

Any number of the modules, sub modules, units and sub units according to the embodiments of the present disclosure, or at least part of the functions of any number of them may be implemented in a single one module. Any one or more of the modules, sub modules, units and sub units according to the embodiments of the present disclosure may be split into multiple modules for implementation. Any one or more of the modules, sub modules, units and sub units according to the embodiments of the present disclosure may be implemented at least partially as a hardware circuit, such as a field programmable gate array (FPGA), a programmable logic array (PLA), a system on a chip, a system on a substrate, a system on a package, an Application Specific Integrated Circuit (ASIC), or may be implemented by hardware or firmware in any other reasonable way that integrates or encapsulates the circuit, or can be implemented by any one of the three implementation modes of software, hardware and firmware or an appropriate combination thereof. Alternatively, one or more of the modules, sub modules, units and sub units according to the embodiments of the present disclosure may be at least partially implemented as a computer program module that, when executed, perform the corresponding functions.

FIG. 9 schematically shows a block diagram of an electronic device adapted for performing the method of determining the display page according to an embodiment of the present disclosure.

As shown in FIG. 9, an electronic device 900 according to the embodiment of the present disclosure includes a processor 901, which may execute various appropriate actions and processing according to the program stored in a read only memory (ROM) 902 or the program loaded into a random access memory (RAM) 903 from a storage section 908. The processor 901 may, for example, include a general-purpose microprocessor (for example, CPU), an instruction set processor and/or a related chipset and/or a special-purpose microprocessor (for example, an application specific integrated circuit (ASIC)), and the like. The processor 901 may also include an on-board memory for caching purposes. The processor 901 may include a single processing unit or multiple processing units for executing different actions of the method flow according to the embodiments of the present disclosure.

In the RAM 903, various programs and data required for the operation of the system 900 are stored. The processor 901, the ROM 902 and the RAM 903 are connected to each other through a bus 904. The processor 901 executes various operations of the method flow according to the embodiments of the present disclosure by executing the programs in the ROM 902 and/or the RAM 903. It should be noted that the program may also be stored in one or more memories other than the ROM 902 and the RAM 903. The processor 901 may also execute various operations of the method flow according to the embodiments of the present disclosure by executing the programs stored in the one or more memories.

According to the embodiment of the present disclosure, the system 900 may further include an input/output (I/O) interface 905 which is also connected to the bus 904. The system 900 may further include one or more of the following components connected to the I/O interface 905: an input section 906 including a keyboard, a mouse, etc.; an output section 907 including a cathode ray tube (CRT), a liquid crystal display (LCD), etc. and a speaker, etc.; a storage section 908 including a hard disk, etc.; and a communication section 909 including a network interface card such as a LAN card, a modem, and the like. The communication section 909 performs communication processing via a network such as the Internet. A drive 910 is also connected to the I/O interface 905 as required. A removable medium 911, such as a magnetic disk, an optical disk, a magneto-optical disk, a semiconductor memory, and the like, is installed on the drive 910 as required, so that the computer program read therefrom is installed into the storage section 908 as needed.

The method flow according to the embodiments of the present disclosure may be implemented as a computer software program. For example, the embodiments of the present disclosure include a computer program product including a computer program carried on a non-transitory computer-readable storage medium. The computer program includes a program code for execution of the method shown in the flowchart. In such an embodiment, the computer program may be downloaded and installed from the network through the communication section 909, and/or installed from the removable medium 911. When the computer program is executed by the processor 901, the above-mentioned functions defined in the system of the embodiment of the present disclosure are performed. According to the embodiments of the present disclosure, the above-described systems, apparatuses, devices, modules, units, etc. may be implemented by computer program modules.

The present disclosure also provides a non-transitory computer-readable storage medium, which may be included in the apparatus/device/system described in the above embodiments; or exist alone without being assembled into the apparatus/device/system. The above-mentioned non-transitory computer-readable storage medium carries one or more programs that when executed, perform the method according to the embodiments of the present disclosure.

According to the embodiments of the present disclosure, the non-transitory computer-readable storage medium may be a non-volatile computer-readable storage medium, for example, may include but not limited to: portable computer disk, hard disk, random access memory (RAM), read-only memory (ROM), erasable programmable read-only memory (EPROM or flash memory), portable compact disk read-only memory (CD-ROM), optical storage device, magnetic storage device, or any suitable combination of the above. In the present disclosure, the non-transitory computer-readable storage medium may be any tangible medium that includes or stores programs that may be used by or in combination with an instruction execution system, apparatus, or device. For example, according to the embodiments of the present disclosure, the non-transitory computer-readable storage medium may include the above-mentioned ROM 902 and/or RAM 903 and/or one or more memories other than the ROM 902 and RAM 903.

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, program segment, or code, which part includes one or more executable instructions for implementing the specified logical function. It should also be noted that, in some alternative implementations, the functions noted in the blocks may also occur in a different order than that noted in the accompanying drawings. For example, two blocks shown in succession may actually be executed substantially in parallel, or they may sometimes be executed in the reverse order, depending on the functions involved. It should also be noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions.

Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

The embodiments of the present disclosure have been described above. However, these embodiments are for illustrative purposes only, and are not intended to limit the scope of the present disclosure. Although the embodiments have been described separately above, this does not mean that measures in the respective embodiments cannot be used in combination advantageously. The scope of the present disclosure is defined by the appended claims and their equivalents. Without departing from the scope of the present disclosure, those skilled in the art can make various substitutions and modifications, and these substitutions and modifications should all fall within the scope of the present disclosure.

1. A method of determining a display page, comprising:
acquiring attribute information of a user, wherein the attribute information comprises position information;
determining, based on the position information, at least one first information category for the user in a preset first information dimension;
acquiring recommendation information classified into each first information category of the at least one first information category; and
determining the display page for the user based on the preset first information dimension, the at least one first information category, and the recommendation information classified into the each first information category.

2. The method according to claim 1, further comprising:
acquiring a preset information classification tree comprising a plurality of root nodes each indicating a second information dimension, wherein each of the plurality of root nodes comprises at least one sub node each indicating a second information category; and
determining a target root node among the plurality of root nodes, wherein the second information dimension indicated by the target root node is matched with the position information;
wherein the determining the display page for the user comprises:
determining the display page for the user based on the first information dimension, the at least one first information category, the recommendation information classified into the each first information category, and the information classification tree,
wherein the display page comprises an information classification tree display control such that the display page displays the sub node comprised in the target root node, in response to an operation on the information classification tree display control.

3. The method according to claim 1, wherein the attribution information further comprises task item information;
wherein the determining the display page for the user comprises:
determining, based on the task item information, target information in the recommendation information classified into the each first information category; and
determining the display page for the user based on the first information dimension, the at least one first information category and the target information.

4. The method according to claim 1, further comprising:
acquiring a browsing history of the user for the recommendation information classified into the each first information category;
wherein the determining the display page for the user comprises:
determining, based on the browsing history, target information in the recommendation information classified into the each first information category; and
determining the display page for the user based on the first information dimension, the at least one first information category, and the target information.

5. The method according to claim 1, further comprising:
acquiring new recommendation information uploaded by a terminal device through a target information platform;
determining, by using a predetermined category determination model, an information category to which the new recommendation information belongs; and
classifying the new recommendation information into the information category to which it belongs.

6. The method according to claim 2, further comprising:
acquiring new recommendation information uploaded by a terminal device through a target information platform;
determining, by using a predetermined category determination model, an information category to which the new recommendation information belongs; and
classifying the new recommendation information into the information category to which it belongs.

7. The method according to claim 5, wherein the target information platform comprises at least one of an information storage platform, a video playback platform, a document editing platform, an information exchange platform, and a project management platform.

8. The method according to claim 6, wherein the target information platform comprises at least one of an information storage platform, a video playback platform, a document editing platform, an information exchange platform, and a project management platform.

9. An electronic device, comprising:
one or more processors; and
a storage device for storing one or more programs,
wherein the one or more programs, when executed by the one or more processors, cause the one or more processors to perform the method according to claim 1.

10. An electronic device, comprising:
one or more processors; and
a storage device for storing one or more programs,
wherein the one or more programs, when executed by the one or more processors, cause the one or more processors to perform the method according to claim 2.

11. An electronic device, comprising:
one or more processors; and
a storage device for storing one or more programs,
wherein the one or more programs, when executed by the one or more processors, cause the one or more processors to perform the method according to claim 3.

12. An electronic device, comprising:
one or more processors; and
a storage device for storing one or more programs,
wherein the one or more programs, when executed by the one or more processors, cause the one or more processors to perform the method according to claim 4.

13. An electronic device, comprising:
one or more processors; and
a storage device for storing one or more programs,
wherein the one or more programs, when executed by the one or more processors, cause the one or more processors to perform the method according to claim 5.

14. An electronic device, comprising:
one or more processors; and
a storage device for storing one or more programs,
wherein the one or more programs, when executed by the one or more processors, cause the one or more processors to perform the method according to claim 6.

15. An electronic device, comprising:
one or more processors; and
a storage device for storing one or more programs,
wherein the one or more programs, when executed by the one or more processors, cause the one or more processors to perform the method according to claim 7.

16. An electronic device, comprising:
one or more processors; and
a storage device for storing one or more programs,
wherein the one or more programs, when executed by the one or more processors, cause the one or more processors to perform the method according to claim 8.

17. A non-transitory computer-readable storage medium having executable instructions stored thereon that, when executed by a processor, cause the processor to perform the method according to claim 1.
